(19) United States
(12) Patent Application Publication
(10) Pub. No.: US 2017/0003127 A1
(43) Pub. Date: Jan. 5, 2017

(54) SPIRIT LEVEL

(71) Applicant: SOLA-Messwerkzeuge GmbH, Goetzis (AT)

(72) Inventors: Roman LAESSER, Goetzis (AT); Wolfgang SCHEYER, Goetzis (AT)

(21) Appl. No.: 15/200,624

(22) Filed: Jul. 1, 2016

(30) Foreign Application Priority Data
Jul. 3, 2015 (AT) A 427/2015

(51) Int. Cl. G01C 9/34

(52) U.S. Cl. CPC G01C 9/34

(57) ABSTRACT

A spirit level comprising a spirit level body formed from a profile member, at least one bubble level arranged in the spirit level body, and at least one magnet arranged in the interior of the spirit level body for exerting a holding force in relation to a measurement surface of the spirit level, wherein the at least one magnet is fixed in or at a carrier element and provided in the profile member of the spirit level body is a chamber or guide in which the carrier element is mounted.

The invention concerns a spirit level having the features of the classifying portion of claim 1.

Spirit levels are known from the state of the art, in which there is provided a magnet for producing a holding force between the spirit level and an object to be measured. Thus for example EP 0 919 786 A1 discloses a spirit level in which a permanent magnet fixed to the spirit level by means of a spring can be coupled to an object to be measured for the duration of a measurement operation. For that purpose, provided in the sole of the spirit level is an opening through which the magnet can be coupled to the object to be measured, for example a surface. A disadvantage with that structure is that the measurement surface of the spirit level is interrupted by the necessary opening. In addition, complicated and expensive mechanical post-machining of the spirit level body which is generally in the form of a hollow profile is required.

WO 97/13119 discloses a spirit level having a magnet held in the interior of the spirit level. In that case the measurement surface of the spirit level is not interrupted. The magnet bears against the inside wall of the side surface forming the measurement surface and can thus exert a holding force through the spirit level body. The magnet itself is arranged in the spirit level body in an additional carrier body (“insertion element”), wherein the insertion element can be inserted into the spirit level body and held therein in the assembled condition.

The object of the present invention is to provide a spirit level which is improved over the state of the art.

That object is attained by a spirit level having the features of claim 1. Advantageous configurations are recited in the appendant claims.

The fact that the at least one magnet is fixed in or at a carrier element and provided in the profile of the spirit level body is a chamber or guide in which the carrier element is mounted provides the option of introducing the magnet or magnets into the spirit level body in hindrance-free fashion and without an additional carrier body, and mounting it or them therein.

Hindrance-free means that, in contrast to the state of the art, the carrier element which carries the magnets can be positioned, if desired, along the entire length of the spirit level body. That is not the case in structures which are based on an additional carrier body.

The, profile member forming the spirit level body can be in the form of a hollow-chamber profile member, a C-shaped profile member or a profile having a hollow chamber.

The fact that the chamber or guide is in the form of part of the profile member itself means that there is no need for an additional carrier body, for example a plastic injection molding, for receiving the magnet or magnets. In other words therefore, in manufacture of the profile member serving as the spirit level body, the chamber or guide is also produced therewith, for example being suitably taken into consideration in designing the configuration of the profile member in an injection molding method. Preferably the spirit level body is produced by way of an injection molding method.

The chamber or guide allows for precise positioning of the carrier element together with the magnets fixed thereto. The carrier element can be introduced by way of an end face of the spirit level body.

The chamber or guide is of such a configuration that the one inserted carrier element is mounted in elastically clamped relationship and the magnet or magnets come to lie near the inside wall of the measurement surface.

It is preferably provided for that purpose that the profile member forming the spirit level body is thinned out in the region of the magnets so that a stronger force is caused to act by the magnets on the object to be measured. The carrier element is held in the spirit level body in positively locking relationship by the chamber or guide and is thus insensitive to shocks and vibration. Besides the positively locking relationship which is present in any case the carrier element can additionally be secured by way of adhesive or welds

It is preferably provided that the at least one chamber or guide extends substantially over the entire length of the spirit level. That can be implemented for example by the guide for the carrier element already being provided in the profile member forming the spirit level body (generally an aluminum extrusion profile member), at the side of the profile member that is towards the measurement surface.

It can also be provided that the at least one chamber or guide is present only in portions over the longitudinal extent of the spirit level.

It can be provided that the carrier element is made from plastic. Preferably metallic particles, preferably ferromagnetic particles, are embedded in the plastic. In that way the carrier element can have the magnetic flux passing therethrough.

It is preferably provided that the carrier element comprises a ferromagnetic material preferably steel

By virtue of the carrier element having ferromagnetic properties—whether by virtue of embedded particles or due to intrinsic properties of the material of the carrier element—the magnet effect is increased and the holding force linked thereto in this case of the magnet or magnets arranged on the carrier element is distributed over the entire length of the carrier element.

That is advantageous over a point-form holding force between the spirit level and the object to be measured, as it usual in the state of the art. Release of the spirit level after the conclusion of the measurement operation is also facilitated by the invention.

The invention is described in greater detail hereinafter by reference to the Figures in which:

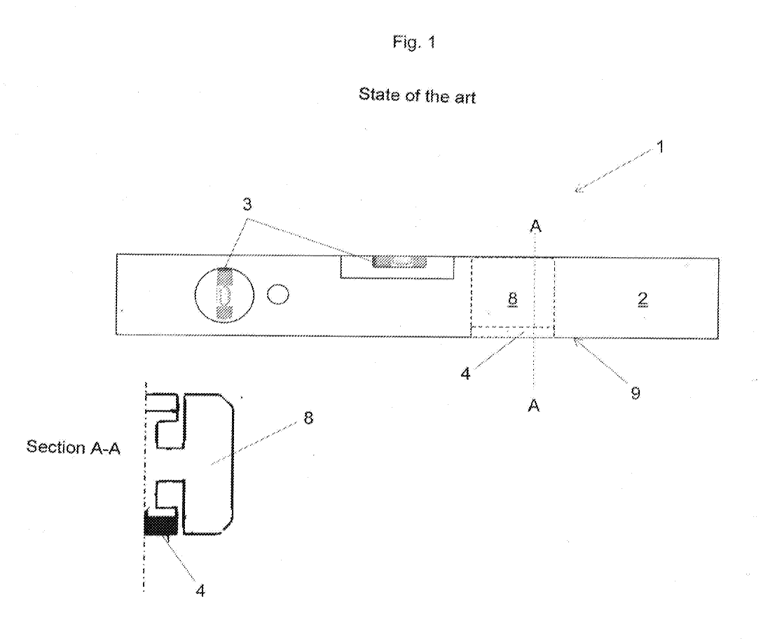

FIG. 1 shows a spirit level according to the state of the art,

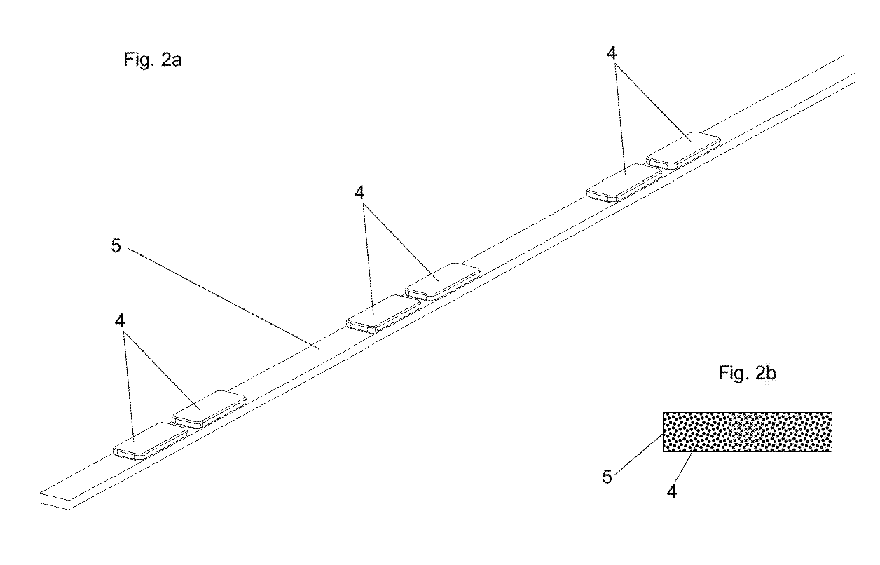

FIGS. 2a and 2b show carrier elements in two embodiments, and

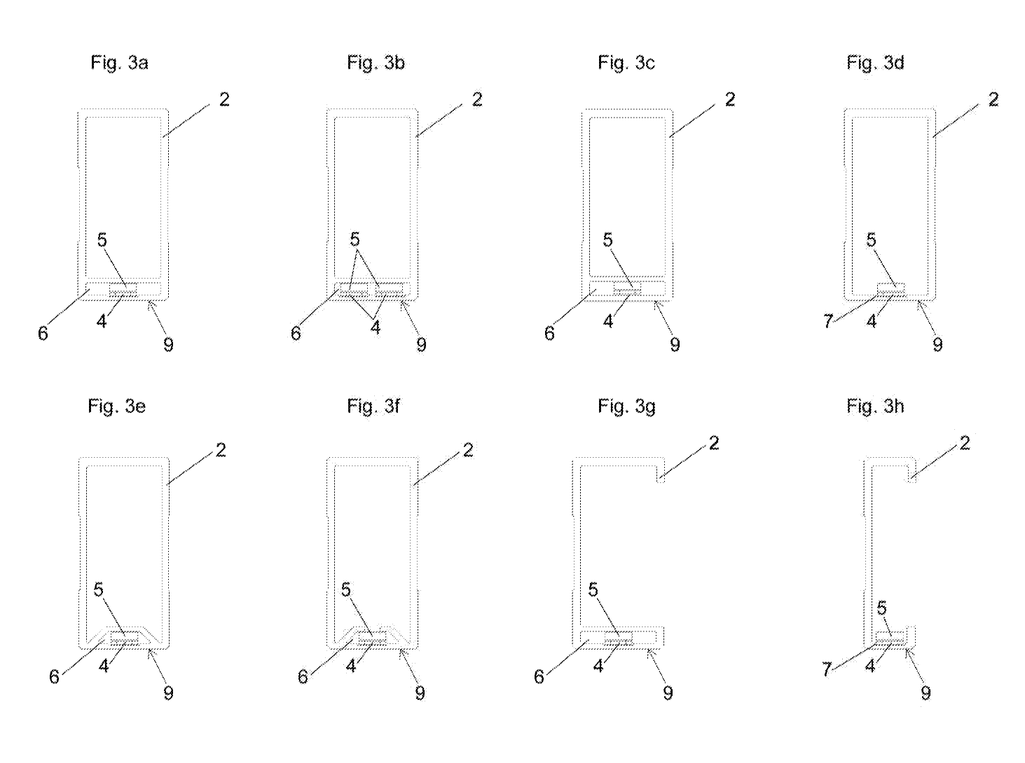

FIGS. 3a through 3h show various variants in the configuration of the chamber 6 or the guide 7.

FIG. 1 shows a spirit level according to the state of the art, wherein a magnet 4 is arranged in the interior of the spirit level body 2 and terminates flush with an opening in the spirit level body 2 at the measurement surface 9. In a variant the magnet 4 is arranged in a carrier body 8 in the spirit level body 2.

FIG. 2a shows a carrier element 5 on which six magnets 4 are arranged in pair-wise fashion. It has been found in tests that the pair-wise arrangement of magnets 4 is particularly advantageous for magnetic flux passing through the carrier element 5 and thus the holding force to be achieved.

FIG. 2b shows the cross-section of a carrier element 5 in the form of a plastic bar in which ferromagnetic particles are embedded as magnets 4. Production can be implemented for example by extrusion of a plastic material loaded with ferromagnetic particles.

FIGS. 3a through 3h show various variants of the configuration of the chamber 6 or the guide 7 for receiving the carrier element 5 and the magnet 4.

In FIG. 3a the chamber 6 or the guide 7 for receiving the carrier element 5 and the magnet 4 is in the form of a chamber having a groove in the spirit level body 2 for additionally guiding the magnet 4. The groove is provided at the inside of that side wall of the spirit level body 2, the outside of which forms the measurement surface 9.

In FIG. 3b two carrier elements 5 with magnets 4 are arranged in the chamber 6.

FIG. 3c shoe a variant of the chamber 6 without additional groove inn the spirit level body 2

FIG. 3d shows a variant in which the spirit level body 2 does not have a chamber 6 but a groove as the guide 7. In this variant the carrier element would be additionally secured by adhesive.

FIG. 3e shows a variant in which the chamber 6 narrows in the direction of the interior of the spirit level body 2.

In the example in FIG. 3f the chamber 6 is not closed but has an opening in relation to the interior of the spirit level body 2.

FIG. 3g shows the variant in which the profile member of the spirit level body 2 is open and the chamber 6 is closed.

In the variant shown in FIG. 3h the profile member of the spirit level body 2 is open. The carrier element 5 is held by the guide 7.

### LIST OF REFERENCES USED

1 spirit level

2 spirit level body

3 bubble level

4 magnet

5 carrier element

6 chamber

7 guide

8 carrier body

9 measurement surface

1. A spirit level comprising a spirit level body formed from a profile member, at least one bubble level arranged in the spirit level body, and at least one magnet arranged in the interior of the spirit level body for exerting a holding force in relation to a measurement surface of the spirit level, wherein the at least one magnet is fixed in or at a carrier element and provided in the profile member of the spirit level body is a chamber or guide in which the carrier element is mounted.

2. A spirit level as set forth in claim 1 wherein the at least one chamber or guide extends substantially over the entire length of the spirit level.

3. A spirit level as set forth in claim 1 wherein the chamber or guide extends only portion-wise in the interior of the spirit level body.

4. A spirit level as set forth in claim 1 wherein the carrier element is made of plastic.

5. A spirit level as set forth in claim 4 wherein metallic particles, preferably ferromagnetic particles, are embedded in the plastic.

6. A spirit level as set forth in claim 1 wherein the carrier element comprises a ferromagnetic material, preferably steel.
